(19) United States
(12) Patent Application Publication
(10) Pub. No.: US 2013/0276756 A1
(43) Pub. Date: Oct. 24, 2013

(54) REDUCING INTAKE MANIFOLD PRESSURE DURING CRANKING

(71) Applicants: Thomas G. Leone, Ypsilanti, MI (US); Ross Dykstra Pursifull, Dearborn, MI (US)

(72) Inventors: Thomas G. Leone, Ypsilanti, MI (US); Ross Dykstra Pursifull, Dearborn, MI (US)

(73) Assignee: FORD GLOBAL TECHNOLOGIES, LLC, Dearborn, MI (US)

(21) Appl. No.: 13/449,580

(22) Filed: Apr. 18, 2012

(51) Int. Cl. F02D 41/30

(52) U.S. Cl. 123/445

(57) ABSTRACT

Embodiments for starting an engine are provided. In one embodiment, an engine control method comprises, during engine cranking, commencing fuel injection when intake manifold pressure drops below a threshold, the threshold based on fuel volatility. In this way, the stability of engine starts using low volatility fuels may be increased.

### FIELD

The present disclosure relates to starting an internal combustion engine.

### BACKGROUND AND SUMMARY

Alternate fuels have been developed to mitigate the rising prices of conventional fuels, to reduce dependence on imported fuels, and for reducing production of emissions, such as CO₂. For example, alcohol and alcohol-based fuel blends have been recognized as attractive alternative fuels, in particular for automotive applications. However, alcohol and alcohol-based fuels are less volatile than gasoline, and as such may not evaporate effectively under typical engine starting temperature and pressure. Thus, engine starts, particularly cold engine starts, using alcohol and alcohol-based fuels may be difficult. Further, incomplete vaporization of the fuel may reduce fuel economy and degrade emissions.

The inventors have recognized the above issues and provide a method to at least partly address them. In one embodiment, an engine method comprises, during engine cranking, commencing fuel injection when intake manifold pressure drops below a threshold, the threshold based on the fuel volatility.

In this way, during an engine start, fuel injection may be delayed until intake manifold pressure is reduced to a threshold level. The threshold may be dependent on fuel volatility. For example, E100 fuel (100% ethanol) may be less volatile than E85 fuel (approximately 85% ethanol, 15% gasoline). As such, when injecting E100 fuel, fuel injection may be delayed until intake manifold pressure drops below a threshold that is lower than the threshold intake manifold pressure for starting an engine with E85 fuel. By injecting fuel after intake manifold pressure drops to a threshold dependent on fuel volatility, fuel vaporization of low-volatility fuels may be improved, without unnecessarily extending crank times.

Intake manifold pressure may be reduced by applying a vacuum source to the intake manifold. In one example, intake manifold pressure may be reduced via a vacuum pump coupled to the intake manifold. The pump may be operated during cranking to reduce intake pressure. To further increase intake manifold vacuum, one or more valves coupled to the intake manifold may be closed to minimize leakage of air into the manifold. For example, a positive crankcase ventilation system may be modified to include an electronically-controlled PCV valve that may be commanded closed during engine cranking.

The present disclosure may offer several advantages. By delaying fuel injection until a time when intake manifold pressure is below a threshold, engine starts using low-volatility fuels may be improved, thus increasing the practicality of utilizing such fuels. Additionally, by evaporating most of the injected fuel, less fuel may be lost during engine operation, and the need for larger or pilot fuel injections at engine cold-start may be reduced. As such, this may provide fuel economy benefits as well as reduced cold-start exhaust emissions.

The operation of a vacuum pump during engine starts may also provide advantages when other, higher-volatility fuels are utilized, such as gasoline. For example, utilizing the vacuum pump to increase manifold vacuum during cranking may provide for a smaller fuel flow and increased fuel evaporation, lowering emissions. Additionally, in conditions where a manifold absolute pressure-controlled start is enabled, such as during an automatic start following an idle stop, increased intake vacuum may provide for faster, more stable starts, regardless of altitude.

If the electric vacuum pump is engaged in an anticipation of an engine start, the engine cranking time to achieve a low MAP can be reduced, thus preventing the operator form noticing an extended cranking time.

The above advantages and other advantages, and features of the present description will be readily apparent from the following Detailed Description when taken alone or in connection with the accompanying drawings.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1 shows an example engine system according to an embodiment of the present disclosure.

FIG. 2 shows a single cylinder of the multi-cylinder engine of FIG. 1.

FIG. 3 is a flow chart illustrating a method for starting an engine according to an embodiment of the present disclosure.

FIG. 4 is an example diagram showing various operating parameters during an engine start according to an embodiment of the present disclosure.

FIG. 5 is an example diagram showing various operating parameters during an engine start according to another embodiment of the present disclosure.

### DETAILED DESCRIPTION

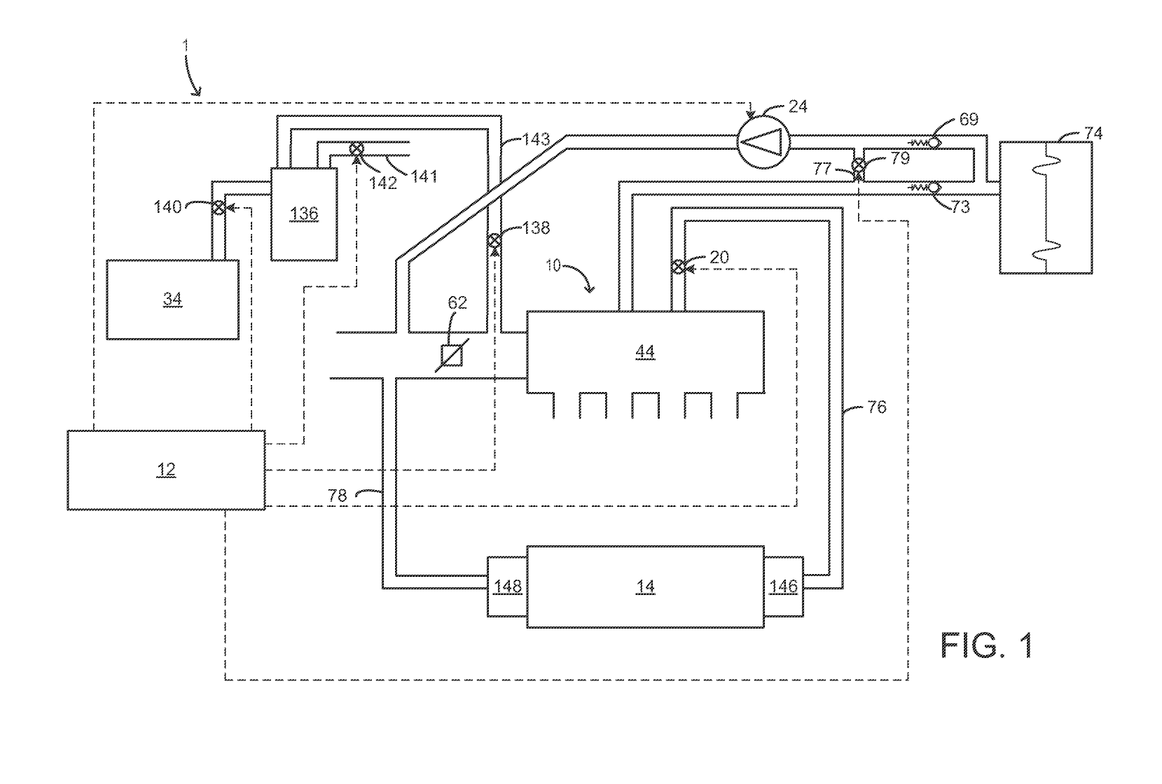

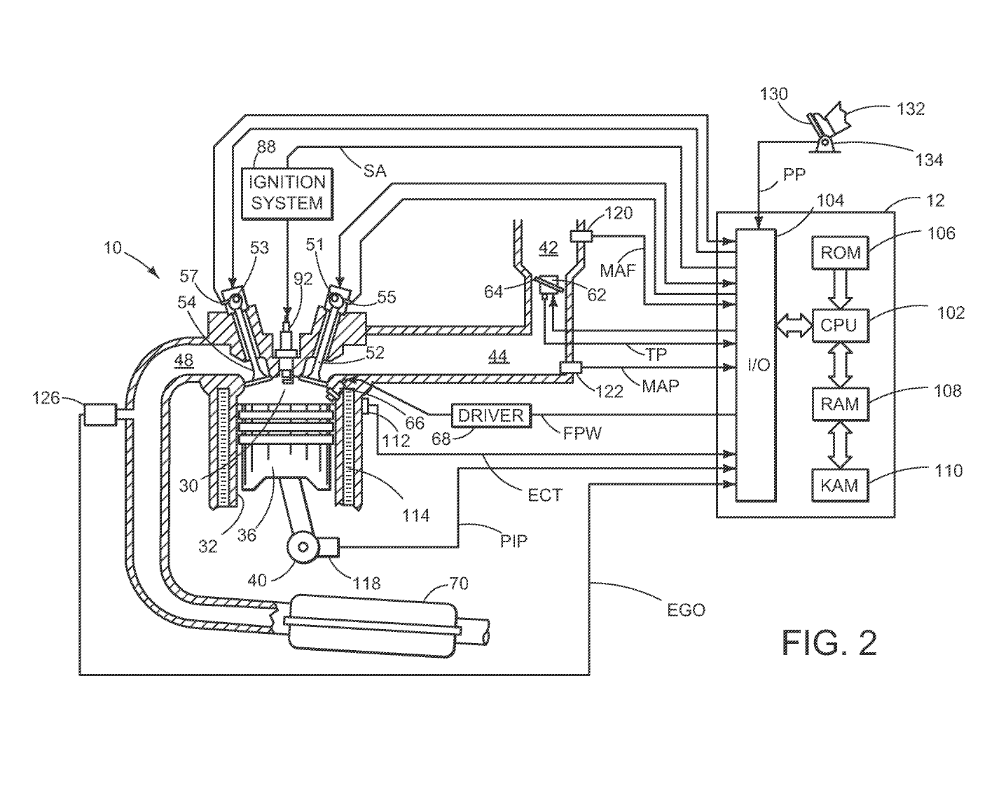

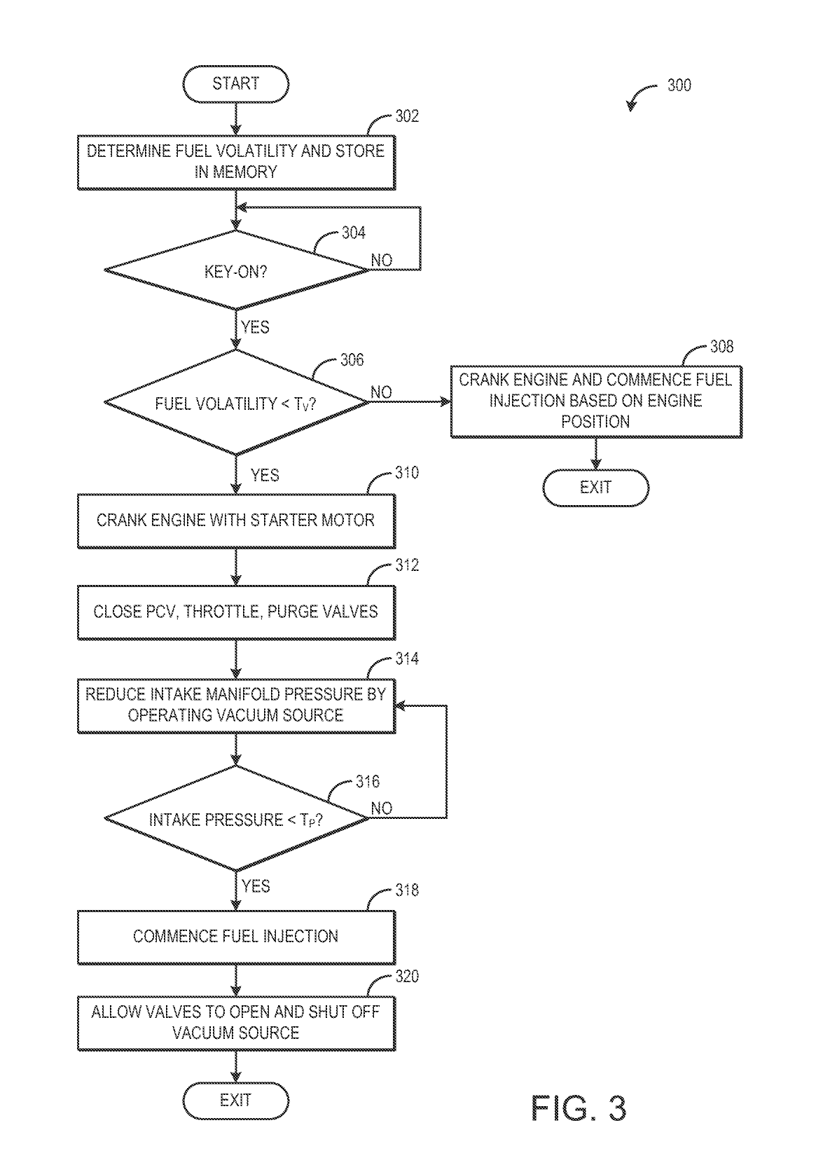

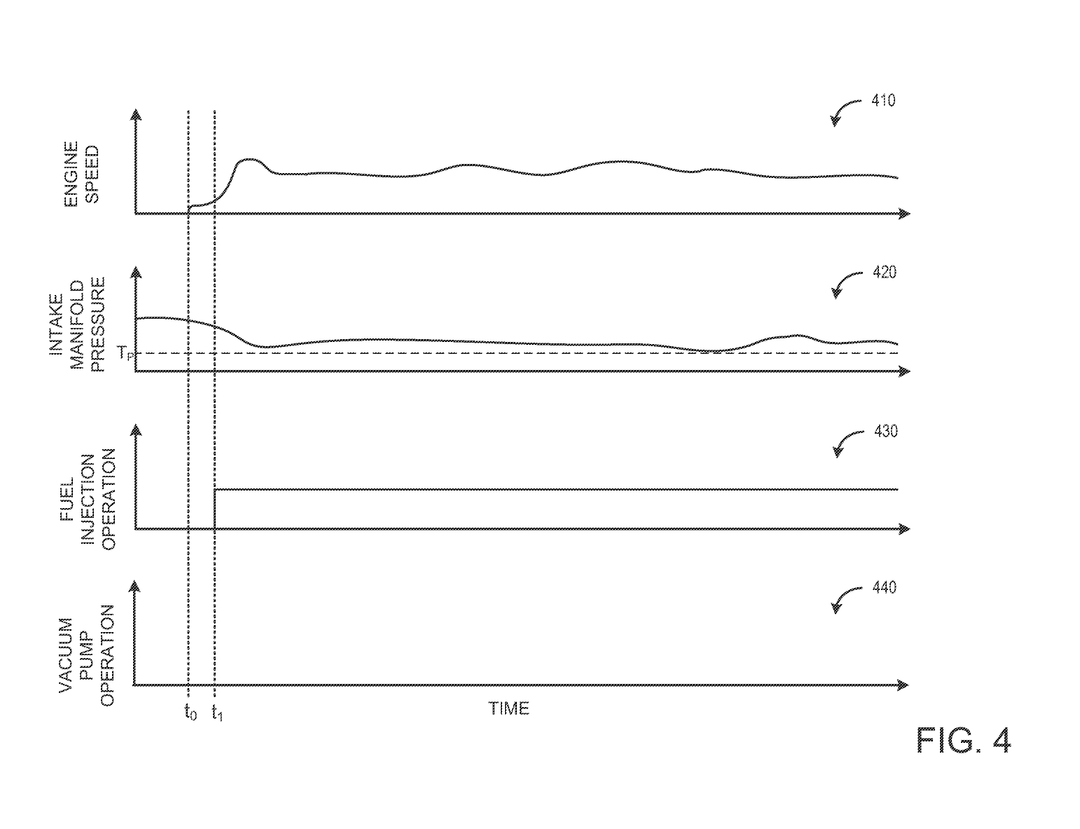

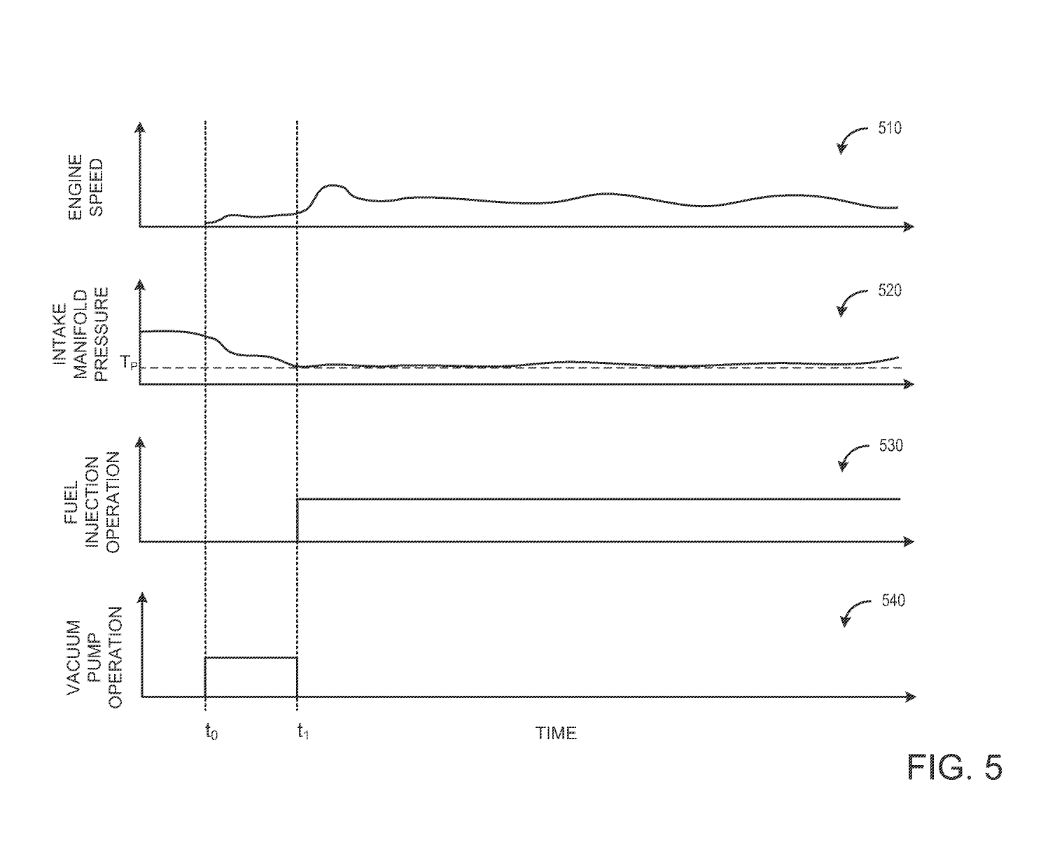

Low volatility fuels, such ethanol and ethanol-gasoline blends, may not evaporate as effectively as gasoline during typical engine starting conditions. As a result, fuel economy and emissions may degrade, and cold engine starts may be unreliable. To increase the evaporation of low-volatility fuels, intake manifold vacuum may be increased during cranking via a vacuum source, such as a vacuum pump, coupled to the intake manifold. Further, one or more controllable valves coupled to the intake manifold, such as the throttle and PCV valve, may be commanded closed to ensure rapid evacuation of the intake manifold. The intake manifold vacuum may be increased to a threshold level, at which time fuel injection may commence. The threshold level of vacuum may be proportional to the volatility of the injected fuel. FIGS. 1 and 2 are example engine diagrams including a fuel injection system, vacuum pump, electronic PCV valve, and controller for carrying out the method illustrated in FIG. 3. FIGS. 4 and 5 are example engine operating parameters during engine start-up.

FIG. 1 shows aspects of an example engine system 1 for a motor vehicle. The engine system includes engine 10. Engine 10 may be virtually any volatile-liquid or gas-fueled internal combustion engine, e.g., a port- or direct-injection spark ignition or compression ignition engine. In one, non-limiting embodiment, the engine may be adapted to consume an alcohol-based fuel—ethanol, for example.

Intake manifold 44 is configured to supply intake air or an air-fuel mixture to one or more combustion chambers of engine 10. The combustion chambers may be arranged above a lubricant-filled crankcase 14, in which reciprocating pistons of the combustion chambers rotate a crankshaft. The reciprocating pistons may be substantially isolated from the crankcase via one or more piston rings, which suppress the flow of the air-fuel mixture and of combustion gasses into the crankcase. Nevertheless, a significant amount of fuel vapor may ‘blow by’ the piston rings and enter the crankcase over time. To reduce the degrading effects of the fuel vapor on the viscosity of the engine lubricant and to reduce the discharge of the vapor into the atmosphere, the crankcase may be continuously or periodically ventilated, as further described hereinafter. In the configuration shown in FIG. 1, a post-throttle positive crankcase-ventilation (PCV) valve 20 controls the admission of ventilation air into the crankcase. The PCV valve may be any fixed or adjustable portioning valve.

Engine system 1 includes fuel tank 34, which stores the volatile liquid fuel combusted in engine 10. To avoid emission of fuel vapors from the fuel tank and into the atmosphere, the fuel tank is vented to the atmosphere through adsorbent canister 136. The adsorbent canister may have a significant capacity for storing hydrocarbon-, alcohol-, and/or ester-based fuels in an adsorbed state; it may be filled with activated carbon granules and/or another high surface-area material, for example. Nevertheless, prolonged adsorption of fuel vapor will eventually reduce the capacity of the adsorbent canister for further storage. Therefore, the adsorbent canister may be periodically purged of adsorbed fuel, as further described hereinafter. To provide venting of fuel tank 34 during refueling, adsorbent canister 136 is coupled to the fuel tank via refueling tank vent 140. As shown valve 140 is a fuel tank isolation valve, isolating the fuel tank from the fuel vapor storage canister. The refueling tank vent may be a normally closed valve which is held open during refueling. Adsorbent canister 136 includes a vent line 141 which may route gases out of the adsorbent canister 136 to the atmosphere when storing, or trapping, fuel vapors from fuel tank 34. Vent line 141 may also allow fresh air to be drawn into adsorbent canister 136 when purging stored fuel vapors from adsorbent canister 136 to intake manifold 44 via purge line 143 and canister-purge valve 138. A canister check valve may also be included in purge line 143 to prevent (boosted) intake manifold pressure from flowing gases into the purge line in the reverse direction. While this example shows vent line 141 communicating with fresh, unheated air, various modifications may also be used. Flow of air and vapors between adsorbent canister 136 and the atmosphere may be regulated by the operation of a canister vent solenoid valve 142 in vent line 141.

The configuration illustrated in FIG. 1 ensures that during refueling, air from fuel tank 34, now stripped of fuel vapor, may be vented to atmospheric pressure. During other conditions, e.g., during a system integrity test, refueling tank vent 140 and/or other systems valves may be closed so that it can be determined whether some isolated part of engine system 1 can hold pressure or vacuum. In some embodiments, throttle 62, PCV valve 20, canister-purge valve 138, tank vent 140, canister vent valve 142, and other actuators may be electronically controlled actuators operatively coupled to controller 12 to facilitate such diagnostics, and other features of engine operation. In an example embodiment of the present disclosure, throttle 62, PCV valve 20, and canister-purge valve 138 may be commanded closed by controller 12 during engine cranking to facilitate generation of intake manifold vacuum, which will be described in more detail herein. Controller 12 may be any electronic control system of the engine system or of the vehicle in which the engine system is installed. Accordingly, the electronic control system may be configured to make control decisions, actuate valves, etc., based at least partly on input from one or more sensors within the engine system. Additional information regarding controller 12 will be presented with respect to FIG. 2 below.

Continuing in FIG. 1, PCV valve 20 is shown in line 76, which couples intake manifold 44 and crankcase 14 via intake-protecting oil separator 146. In one embodiment, the direction of ventilation air flow through the crankcase depends on the relative values of the manifold air pressure (MAP) and the barometric pressure (BP). Under unboosted or minimally boosted conditions (e.g., when BP>MAP) and when PCV valve 20 is open, air enters the crankcase via line 78 and is discharged from the crankcase to intake manifold 44 via line 76. In some embodiments, a second oil separator 148 may be present between crankcase 14 and line 78.

Engine system 1 may further include pump 24 coupled to the intake manifold. Pump 24 may be a vacuum pump utilized for the brake system and/or other accessories and systems. In some embodiments, pump 24 may be used during engine startup to evacuate the intake manifold, as will be described in greater detail below.

Brake booster 74, including a brake booster reservoir, may be coupled to intake manifold 44 via check valve 73. Check valve 73 allows air to flow to intake manifold 44 from brake booster 74 and limits air flow to brake booster 74 from intake manifold 44. Check valve 73 accommodates fast pull down of the reservoir pressure when reservoir pressure (e.g., of brake booster 74) is relatively high and intake manifold pressure is low. Additionally, or alternatively, vacuum pump 24 may be selectively operated via a control signal from controller 12 to supply vacuum to brake booster 74. Check valve 69 allows air to flow to vacuum pump 24 from brake booster 74 and limits air flow to brake booster 74 from vacuum pump 24. Valve 79, positioned in line 77, may be opened in order to evacuate the intake manifold via vacuum pump 24. Brake booster 74 may include an internal vacuum reservoir, and it may amplify force provided by an operator's foot via a brake pedal to a master cylinder for applying vehicle brakes (not shown).

FIG. 2 is a schematic diagram showing one cylinder of multi-cylinder engine 10, which may be included in a propulsion system of an automobile. Engine 10 may be controlled at least partially by a control system including controller 12 and by input from a vehicle operator 132 via an input device 130. In this example, input device 130 includes an accelerator pedal and a pedal position sensor 134 for generating a proportional pedal position signal PP. Combustion chamber (i.e., cylinder) 30 of engine 10 may include combustion chamber walls 32 with piston 36 positioned therein. Piston 36 may be coupled to crankshaft 40 so that reciprocating motion of the piston is translated into rotational motion of the crankshaft. Crankshaft 40 may be coupled to at least one drive wheel of a vehicle via an intermediate transmission system. Further, a starter motor may be coupled to crankshaft 40 via a flywheel to enable a starting operation of engine 10.

Combustion chamber 30 may receive intake air from intake manifold 44 via intake passage 42 and may exhaust combustion gases via exhaust passage 48. Intake manifold 44 and exhaust passage 48 can selectively communicate with combustion chamber 30 via respective intake valve 52 and exhaust valve 54. In some embodiments, combustion chamber 30 may include two or more intake valves and/or two or more exhaust valves.

In this example, intake valve 52 and exhaust valves 54 may be controlled by cam actuation via respective cam actuation systems 51 and 53. Cam actuation systems 51 and 53 may each include one or more cams and may utilize one or more of cam profile switching (CPS), variable cam timing (VCT), variable valve timing (VVT) and/or variable valve lift (VVL) systems that may be operated by controller 12 to vary valve operation. The position of intake valve 52 and exhaust valve 54 may be determined by position sensors 55 and 57, respectively. In alternative embodiments, intake valve 52 and/or exhaust valve 54 may be controlled by electric valve actuation. For example, cylinder 30 may alternatively include an intake valve controlled via electric valve actuation and an exhaust valve controlled via cam actuation including CPS and/or VCT systems.

Fuel injector 66 is shown coupled directly to combustion chamber 30 for injecting fuel directly therein in proportion to the pulse width of signal FPW received from controller 12 via electronic driver 68. In this manner, fuel injector 66 provides what is known as direct injection of fuel into combustion chamber 30. The fuel injector may be mounted in the side of the combustion chamber or in the top of the combustion chamber, for example. Fuel may be delivered to fuel injector 66 by a fuel system (not shown) including a fuel tank, a fuel pump, and a fuel rail. In some embodiments, combustion chamber 30 may alternatively or additionally include a fuel injector arranged in intake manifold 44 in a configuration that provides what is known as port injection of fuel into the intake port upstream of combustion chamber 30.

Intake passage 42 may include a throttle 62 having a throttle plate 64. In this particular example, the position of throttle plate 64 may be varied by controller 12 via a signal provided to an electric motor or actuator included with throttle 62, a configuration that is commonly referred to as electronic throttle control (ETC). In this manner, throttle 62 may be operated to vary the intake air provided to combustion chamber 30 among other engine cylinders. The position of throttle plate 64 may be provided to controller 12 by throttle position signal TP. Intake passage 42 may include a mass air flow sensor 120 and a manifold air pressure sensor 122 for providing respective signals MAF and MAP to controller 12.

Ignition system 88 can provide an ignition spark to combustion chamber 30 via spark plug 92 in response to spark advance signal SA from controller 12, under select operating modes. Though spark ignition components are shown, in some embodiments, combustion chamber 30 or one or more other combustion chambers of engine 10 may be operated in a compression ignition mode, with or without an ignition spark.

Exhaust gas sensor 126 is shown coupled to exhaust passage 48 upstream of emission control device 70. Sensor 126 may be any suitable sensor for providing an indication of exhaust gas air/fuel ratio such as a linear oxygen sensor or UEGO (universal or wide-range exhaust gas oxygen), a two-state oxygen sensor or EGO, a HEGO (heated EGO), a NOx, HC, or CO sensor. Emission control device 70 is shown arranged along exhaust passage 48 downstream of exhaust gas sensor 126. Device 70 may be a three way catalyst (TWC), NOx trap, various other emission control devices, or combinations thereof. In some embodiments, during operation of engine 10, emission control device 70 may be periodically reset by operating at least one cylinder of the engine within a particular air/fuel ratio.

Controller 12 is shown in FIG. 1 as a microcomputer, including microprocessor unit 102, input/output ports 104, an electronic storage medium for executable programs and calibration values shown as read only memory chip 106 in this particular example, random access memory 108, keep alive memory 110, and a data bus. Controller 12 may receive various signals from sensors coupled to engine 10, in addition to those signals previously discussed, including measurement of inducted mass air flow (MAF) from mass air flow sensor 120; engine coolant temperature (ECT) from temperature sensor 112 coupled to cooling sleeve 114; a profile ignition pickup signal (PIP) from Hall effect sensor 118 (or other type) coupled to crankshaft 40; throttle position (TP) from a throttle position sensor; and absolute manifold pressure signal, MAP, from sensor 122. Engine speed signal, RPM, may be generated by controller 12 from signal PIP. Manifold pressure signal MAP from a manifold pressure sensor may be used to provide an indication of vacuum, or pressure, in the intake manifold. Note that various combinations of the above sensors may be used, such as a MAF sensor without a MAP sensor, or vice versa. During stoichiometric operation, the MAP sensor can give an indication of engine torque. Further, this sensor, along with the detected engine speed, can provide an estimate of charge (including air) inducted into the cylinder. In one example, sensor 118, which is also used as an engine speed sensor, may produce a predetermined number of equally spaced pulses every revolution of the crankshaft.

Storage medium read-only memory 106 can be programmed with computer readable data representing instructions executable by processor 102 for performing the methods described below as well as other variants that are anticipated but not specifically listed.

As described above, FIG. 2 shows only one cylinder of a multi-cylinder engine, and that each cylinder may similarly include its own set of intake/exhaust valves, fuel injector, spark plug, etc.

Turning to FIG. 3, a flow chart illustrating a method 300 for starting an engine is depicted. Method 300 may be carried out according to instructions stored in the memory of controller 12 in response to feedback from one or more sensors. At 302, volatility of the fuel that will be used to operate the engine is determined. The volatility of the fuel may be determined during a previous engine operation and the volatility stored in the memory of the controller. In some embodiments, such as in engine systems that include multiple fuel tanks configured to hold different fuels, fuel volatility may be determined during engine operation. Alternatively or additionally, the fuel volatility may be determined following a refueling event. In one embodiment, fuel volatility may be determined by an amount of ethanol present in the fuel. In one example, the fuel composition may be determined based on a previous engine operation. In another example, the fuel composition may be determined based on a fuel tank filling event. Alternatively, the fuel composition may be determined based on the output of a fuel composition sensor, such as a fuel alcohol sensor.

At 304, it is determined if a key-on event is occurring. If no, method 300 returns to continue determining if a key-on event has occurred. If yes, method 300 proceeds to 306 to determine if the fuel volatility previously determined and stored in the memory of the controller is below a volatility threshold T_{V}. The fuel volatility threshold may be a suitable volatility below which the fuel may not sufficiently vaporize at current operating conditions. The volatility threshold may be a fixed threshold that does not change regardless of operating conditions, or it may be a variable threshold that changes based on operating conditions that affect the vaporization of the fuel, such as engine temperature and/or air temperature.

In one non-limiting example, the volatility threshold may be approximately equal to the volatility of gasoline, for example within a range of the volatility of gasoline, such as 10%. Gasoline may have a volatility, expressed in terms of vapor pressure, that ranges from 7.0-15.0 psi, depending on composition due to season and/or geography. The volatility threshold may be set to a volatility within this range, for example, or may be set at the lowest value of this range. As ethanol has a lower volatility than gasoline (e.g., 2.0 psi), its presence in the fuel may reduce the volatility of the fuel to a level below the volatility threshold. Fuel volatility may be expressed in other terms, such as the temperature at which a certain fraction of the fuel evaporates.

If the fuel volatility is not below the threshold, method 300 proceeds to 308 to crank the engine using the starter motor and commence fuel injection after uniquely identifying engine position. As used herein “uniquely identifying engine position” includes not only determining crankshaft position but also determining the stroke of the engine cycle in which each cylinder is operating (e.g., camshaft position). In doing so, fuel injection may commence with the fuel being injected to each cylinder at the desired injection timing (e.g., during the intake stroke) in sequence, referred to as sequential fuel injection.

Crankshaft position may be determined from the crankshaft sensor (such as sensor 118), which may indicate that the engine is in one of two possible positions. Then, the engine position may be selected from the two options based on identification of engine position via one or more cam sensor readings. For example, the location of an unevenly-spaced tooth on a toothed cam wheel may be identified from the cam sensor readings to uniquely identify engine position. Additionally, or alternatively, engine position and cam position may be stored upon shutdown, and then assumed to have remained substantially fixed during the shutdown such that engine position and cam position are known upon engine start, even before any toothed cam wheel sensor edges are detected. In such embodiments, fuel injection may begin with engine cranking. Additionally, controllable valves coupled to the intake manifold may be set to their default positions for engine starting. After commencing fuel injection, method 300 exits.

Returning to 306, if the fuel volatility is lower than the volatility threshold, method 300 proceeds to 310 crank the engine with the starter motor. At 312, one or more valves coupled to the intake manifold may be closed in order to prevent leakage of air into the intake manifold. For example, a PCV valve, throttle valve, and/or canister-purge valve may be commanded closed. In some embodiments, these valves may be commanded to a default closed position during the shut-down of a previous engine operation, and as such may already be in the closed position at the start of engine cranking. PCV valves typically include a default position of being open to a maximum effective flow area. Thus, the default PCV valve position of the present disclosure may be adjusted to be in the closed position. At 314, the intake manifold pressure is reduced. The intake manifold pressure may be reduced by operating a vacuum pump coupled to the intake manifold, and/or by applying a vacuum reservoir to the intake manifold, and/or by other suitable mechanisms for reducing pressure in the intake manifold. The vacuum source may be activated in response to the starter motor cranking the engine. In other embodiments, the vacuum source may be operated before a key-on event so that the intake manifold is already at a pressure below ambient pressure even before cranking starts. For example, the vacuum source may be operated in response to an operator of the vehicle opening a door of the vehicle, or inserting a key into the ignition, etc. In yet other embodiments, vacuum may be applied to the intake manifold after cranking begins, e.g. after a predetermined time or number of engine revolutions, or when a predetermined engine speed is attained, in order to most effectively apply the available vacuum (e.g. from a vacuum reservoir). Additionally, by operating the vacuum source, a target MAP may be achieved before injection, improving “MAP at first injection” variability due to such things as variable amounts of brake booster vacuum replenishment and variability in engine synchronization.

At 316, it is determined if intake manifold pressure is below a pressure threshold T_{P}. The pressure threshold may be based on the determined volatility of the fuel. For example, lower volatility fuels (such as E100) may have lower pressure thresholds than higher volatility fuels (such as E10). In some embodiments, the pressure threshold may be adjusted based on operating parameters. In one example, the pressure threshold for a given fuel volatility may be increased as ambient and/or engine temperature increases. The intake manifold pressure may be determined by one or more sensors in the intake manifold. In another embodiment, the intake manifold pressure may be estimated based on, for example, an amount of time since the vacuum pump was started, and/or based on a number of engine revolutions since cranking started.

If the intake manifold pressure is not below the pressure threshold, method 300 returns to continue to reduce manifold pressure. If the pressure is below the threshold, method 300 proceeds to 318 to commence fuel injection. At 320, the controllable valves coupled to the intake manifold may be allowed to open depending on operating conditions, and/or the vacuum source may be shut off. The vacuum source may be shut off once fuel injection begins, or it may be shut off after a threshold engine speed has been reached, or after a threshold number of engine cycles, etc. Upon shutting off the vacuum source, method 300 exits.

Thus, method 300 of FIG. 3 provides for an engine method comprising, if fuel ethanol content is equal to or below a threshold, then cranking the engine and commencing fuel injection after uniquely identifying engine position, and if fuel ethanol content is above the threshold, then cranking the engine and commencing fuel injection based on intake manifold pressure. In some embodiments, the threshold fuel ethanol content may no fuel ethanol content. In other embodiments, the threshold fuel ethanol content may be a relatively low amount of ethanol, such as 10%.

In this way, when fuel ethanol content is below the threshold, e.g., when fuel volatility is high, fuel injection may commence after uniquely identifying engine position. During engine start under these parameters, fuel injection commencement is not based on intake manifold pressure, but starts as soon as engine position is determined, even if intake pressure is above the pressure threshold. By doing so, rapid engine starts may be achieved without utilizing energy for operating the vacuum pump. However, when fuel ethanol content is above the threshold, fuel injection commencement is based on intake manifold pressure, and begins once the intake pressure reaches the threshold. By utilizing a vacuum pump to quickly reduce the intake manifold pressure, the stability of engine starts with low volatility fuels may be improved without prolonged engine cranking.

As explained previously, the volatility threshold/fuel ethanol content threshold, and/or the pressure threshold for starting fuel injection may vary based on operating parameters. For example, during an engine start when engine temperature is hot, the pressure threshold may be increased. Due to the higher engine temperature, the fuel, even low volatility fuel, may vaporize at a higher pressure. In another example, the volatility threshold may change based on engine temperature. If engine temperature is so cold that even a relatively high volatility fuel, such as unblended gasoline, may not vaporize effectively, the volatility threshold may be changed so that fuel injection may begin once intake manifold pressure drops below a threshold.

In other embodiments, an intake manifold pressure-based fuel injection commencement may be utilized even with high volatility fuels such as unblended gasoline. For example, the vacuum pump may be operated and/or the controllable valves closed while executing a MAP-based start, such as an automatic stop following an idle shut-down.

FIGS. 4 and 5 are example diagrams illustrating various engine operating parameters during an engine start. FIG. 4 shows operating parameters during an engine start wherein fuel injection commences based on engine position (and not intake manifold pressure) and FIG. 5 shows operating parameters during an engine start wherein fuel injection commences based on intake manifold pressure. Referring to FIG. 4, engine speed is depicted in diagram 410, intake manifold pressure is depicted in diagram 420, fuel injection operation is depicted in diagram 430, and vacuum pump operation is depicted in diagram 440. Each diagram depicts time along the x axis and a respective operating parameter along the y axis.

Time t₀ indicates a key-on event. Prior to t₀, the engine is not operating. As such, engine speed is zero, intake manifold pressure is at ambient pressure, and no fuel injection is occurring. Following the key-on event, the starter motor cranks the engine, causing engine speed to increase and as a result intake manifold pressure begins to decrease. Fuel injection starts at time t₁. Fuel injection may begin once engine position is uniquely identified. Following the start of fuel injection, the engine may start combustion, and engine speed increases and intake manifold pressure decreases. Also shown in diagram 420 is a pressure threshold T_{P}. The pressure threshold depicted in diagram 420 may be the pressure threshold that would be set for a low volatility fuel, such as E100. As the fuel injection commences based on engine position and not on intake manifold pressure, fuel injection starts even if intake manifold pressure is above the threshold. Furthermore, as depicted in diagram 440, the vacuum pump is not operated during the engine start, as fuel injection is based on engine position and not on intake manifold pressure.

FIG. 5 shows operating parameters similar to FIG. 4, with engine speed depicted in diagram 510, intake manifold pressure depicted in diagram 520, fuel injection operation depicted in diagram 530, and vacuum pump operation depicted in diagram 540. Unlike the embodiment discussed above with respect to FIG. 4, the embodiment of FIG. 5 commences fuel injection based on intake manifold pressure. Following the key-on event at t₀, fuel injection is delayed as the intake manifold pressure decreases, due to operation of the vacuum pump, which in the embodiment depicted in FIG. 5, starts at the key-on event at time t₀. Once intake manifold pressure reaches the pressure threshold at time t₁, fuel injection commences and the vacuum pump is shut off. As a result, in the embodiment of FIG. 5, fuel injection begins at a lower intake manifold pressure than the intake manifold pressure at the start of fuel injection of the embodiment of FIG. 4.

It will be appreciated that the configurations and methods disclosed herein are exemplary in nature, and that these specific embodiments are not to be considered in a limiting sense, because numerous variations are possible. For example, the above technology can be applied to V-6, 1-4, 1-6, V-12, opposed 4, and other engine types. The subject matter of the present disclosure includes all novel and non-obvious combinations and sub-combinations of the various systems and configurations, and other features, functions, and/or properties disclosed herein.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure

1. An engine control method, comprising:
during engine cranking, commencing fuel injection when intake manifold pressure drops below a threshold, the threshold based on a fuel volatility.

2. The engine control method of claim 1, wherein the threshold decreases as fuel volatility decreases.

3. The engine control method of claim 2, wherein the threshold decreases proportionally with decreasing fuel volatility.

4. The engine control method of claim 2, further comprising operating a vacuum pump during engine cranking to reduce intake manifold pressure.

5. The engine control method of claim 2, further comprising opening a valve to a vacuum reservoir during cranking to reduce intake manifold pressure.

6. The engine control method of claim 2, further comprising closing a PCV valve during engine cranking.

7. The engine control method of claim 2, further comprising closing a throttle and a canister-purge valve during engine cranking.

8. An engine system comprising:
a vacuum source coupled to an intake manifold;
a fuel injection system;
a positive crankcase ventilation system including a PCV valve; and
a controller including instructions to:
during cranking of the engine, close the PCV valve and operate the vacuum source to reduce intake manifold pressure, and
commence fuel injection when the intake manifold pressure reaches a threshold, said threshold decreasing for lower fuel volatility.

9. The engine system of claim 8, wherein the vacuum source is a vacuum pump.

10. The engine system of claim 8, wherein the vacuum source is a vacuum reservoir.

11. The engine system of claim 8, wherein the controller includes further instructions to close a throttle valve and a canister-purge valve during engine cranking.

12. The engine system of claim 8, wherein the controller includes further instructions to stop operation of the vacuum source after fuel injection commences.

13. The engine system of claim 8, wherein the threshold is approximately equal to a volatility of gasoline.

14. An engine control method, comprising:
if fuel ethanol content is equal to or below a threshold, then cranking the engine and commencing fuel injection after uniquely identifying engine position; and
if fuel ethanol content is above the threshold, then cranking the engine and commencing fuel injection based on intake manifold pressure.

15. The engine control method of claim 14, wherein commencing fuel injection based on intake manifold pressure further comprises commencing fuel injection when intake manifold pressure drops below a pressure threshold.

16. The engine control method of claim 15, wherein as fuel ethanol content increases, the pressure threshold decreases.

17. The engine control method of claim 14, further comprising, if fuel ethanol content is above the threshold, reducing intake manifold pressure by operating a vacuum source during engine cranking.

18. The engine control method of claim 17, wherein the vacuum source is a vacuum pump.

19. The engine control method of claim 17, wherein the vacuum source is a vacuum reservoir.

20. The engine control method of claim 14, further comprising, if fuel ethanol content is above the threshold, closing a PCV valve, throttle valve, and canister-purge valve during engine cranking, and wherein the threshold is no fuel ethanol content.
